(19) United States
(12) Patent Application Publication
(10) Pub. No.: US 2003/0053119 A1
(43) Pub. Date: Mar. 20, 2003

(54) Computer device, control method thereof, program and storage medium

(76) Inventors: Akitoshi Yamada, Kanagawa (JP); Hirokazu Uchio, Tokyo (JP); Kenji Takahashi, Kanagawa (JP)

Correspondence Address: ROBIN BLECKER & DALEY, 2ND FLOOR, 330 MADISON AVENUE, NEW YORK, NY, 10017, US

(21) Appl. No.: 10/217,095

(22) Filed: Aug. 12, 2002

(30) Foreign Application Priority Data
Aug. 22, 2001 (JP) 251345/2001 (PAT.
Aug. 22, 2001 (JP) 251346/2001 (PAT.

(51) Int. Cl. B41J 1/00; G06F 15/00

(52) U.S. Cl. 358/1.15

(57) ABSTRACT

The present invention aims at providing a computer device, a control method thereof, a program and a storage medium thereof, by which printing corresponding to a progress of game software can be executed. Pieces of characters-used game software packaged with cards on which illustrations of the characters etc. are printed, have been put on sale over the recent years. On the other hand, for instance, a game player is able to print an image displayed on a display unit as the necessity may arise but is unable to obtain a hardcopy of a predetermined card etc. just at a preprogrammed scene according to a stage of progress of the game. It is therefore impossible to perform a card creation related to the progress of the game based on the game software. According to the computer device, the control method thereof, the program and the storage medium of the present invention, the program has a function of making the computer device execute the game and advance the game (step 503), then making the computer device control printing an image corresponding to the progress of the game (step 506), whereby printing corresponding to the progress of the game software can be effected.

### BACKGROUND OF THE INVENTION

1. Field of the Invention

The present invention relates to a computer device, a control method thereof, a program and a storage medium thereof.

2. Description of the Background Art

A technology of obtaining a hardcopy of a computer-based image displayed on a display unit has hitherto been known. Further, over the recent years, there have been spread cards on which illustrations of characters in popular animations are printed, and pieces of character-used game software packaged with these cards have been sold.

According to the example of the prior art described above, for instance, a player is able to print an image displayed on the displayed unit as the necessity may arise but is unable to obtain a hardcopy of a predetermined card etc. just at a preprogrammed scene corresponding to a stage of progress of the game. It is therefore impossible to perform a card creation related to the progress of the game based on the game software.

Accordingly, it is a primary object of the present invention, which was devised under such circumstances, to provide a computer device, a control method thereof, a program and a storage medium thereof, by which printing corresponding to a progress of game software can be executed.

Further, if scheming to configure a system that hardcopies such a card and so on and if a card output is executed limitlessly, a scarcity value of the card itself declines with the result that the card can not function as a so-called trading card.

It is another object of the present invention, which was devised under such circumstance, to provide a computer device, a control method thereof, a program and a storage medium thereof, by which a quantity of printed materials to be printed can be restricted.

### SUMMARY OF THE INVENTION

The present invention mainly aims at providing a computer device, a control method thereof, a program and a storage medium thereof, by which printing corresponding to a progress of game software can be executed.

The present invention further mainly aims at providing a computer device, a control method thereof, a program and a storage medium thereof, by which a quantity of printed materials to be printed can be restricted.

To accomplish the above objects, according to one aspect of the present invention, a program for making a computer device execute a game, comprises making the computer device progress the game, and making the computer device control a print of an mage corresponding to a progress of the game.

According to another aspect of the present invention, a computer device capable of executing a game on the basis of a given program, comprises control means for controlling a progress of the game on the basis of the program, and print control means for controlling a print of the image in accordance with the progress of the game.

According to a further object of the present invention, a control method of controlling a computer device capable of executing a game on the basis of a given program, comprises controlling a progress of the game on the basis of the program, and controlling a print of the image in accordance with the progress of the game.

According to a still further object of the present invention, there is provided a storage medium stored with a program for making a computer device execute a game, the program comprising making the computer device progress the game, and making the computer device control a print of the image in accordance with the progress of the game.

According to the present invention, the computer device may be exemplified by, e.g., a personal computer, a TV game machine, a mobile computer device and so forth.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is an explanatory system view showing an architecture of a card game system in a first embodiment;

FIG. 2 is a view showing a sample of the card, wherein an output device 1 outputs an image and pieces of information onto a card 8;

FIG; 3 is a block diagram of the card game system;

FIG. 4 is a diagram showing a general gaming method of a card game;

FIG. 5 is a flowchart showing a game program (which contains a normal game and involves a card output) executed by a game device (machine) 2;

FIG. 6 is a flowchart showing the game program (which contains the normal game and involves the card output) executed by the game machine 2;

FIG. 7 is an explanatory system diagram showing an architecture of the card game system;

FIG. 8 is a block diagram of the card game system;

FIG. 9 is a flowchart showing the game program (which contains the normal game and involves the card output) executed by the game machine 2 and an output control device 9;

FIG. 10 is a flowchart showing a program executed by the output control device 9;

FIG. 11 is an explanatory system diagram showing an architecture of the card game system;

FIG. 12 is a view showing a sample of the card, wherein the output device 1 outputs an image and pieces of information onto the card 8;

FIG. 13 is a block diagram of the card game system;

FIG. 14 is a flowchart showing a program executed by the game machine 2;

FIG. 15 is a flowchart showing a game program (which contains the normal game and involves the card output) executed by the game machine 2;

FIG. 16 is a flowchart showing the game program (which contains the normal game and involves the card output) executed by the game machine 2;

FIG. 17 is a flowchart showing a game program (which contains the normal game and involves the card output) executed by the game machine 2; and

FIG. 18 is a flowchart showing the game program (which contains the normal game and involves the card output) executed by the game machine 2 and the output control device 9.

### DETAILED DESCRIPTION OF THE PREFERRED EMBODIMENTS

Preferred embodiments of the present invention will hereinafter be described.

(First Embodiment)

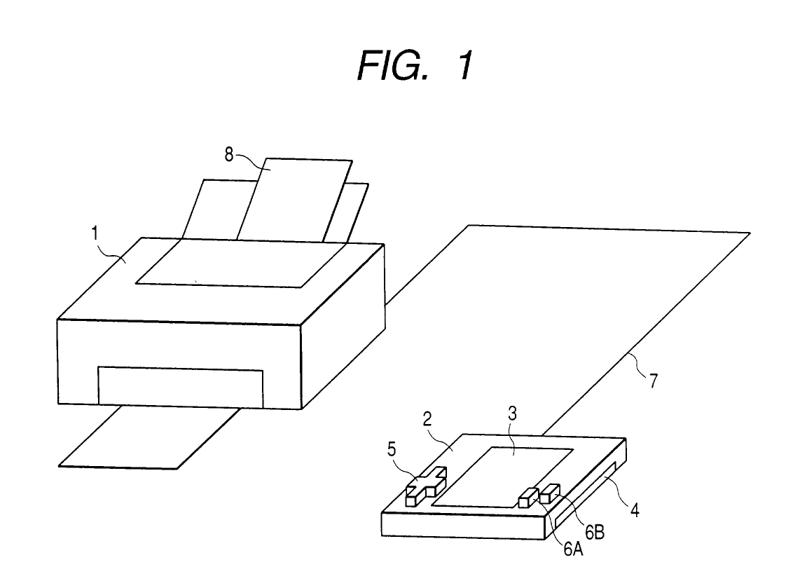

FIG. 1 is an explanatory system diagram showing an architecture of a card game system in a first embodiment of the present invention. An output device 1 is a recording device such as an ink jet printer etc. for outputting a card. Provided on the game device (machine) 2 are a display unit 3 for displaying pieces of game information, a game cartridge insert port 4 into which a game cassette stored with a game content is inserted, a direction input button 5 for inputting up-and-down directions, right-and-left directions and so on, a decision button 6A for specifying a decision and a cancel button 6B for specifying a cancellation. The game machine 2 is connected via a connection cable 7 to the output device 1. Based on the information sent from the game machine 2, the output device 1 records a desired item of card information on a card 8.

The discussion herein is focused on a system in which the output device 1 outputs the card via the wired connection cable 7 from the portable game machine 2 using the game cartridge. Unless specified otherwise, however, the present invention can be, as a matter of course, applied to systems on condition that the functions of the present invention can be executed, wherein the game machine 2 is not of the portable type but is an install-type game machine, and the display unit 3 is a TV (screen) separate from the game machine body. The same is applied to systems in which the medium stored with the game content is not the game cartridge inserted into the game cartridge insert port 4 but a CD-ROM drive and a DVD drive HDD built in the unillustrated game machine 2 or externally attached thereto or connected thereto via a network such as LAN, WAN and so on. For other connection modes, the game machine 2 and the output device 1 are connected to each other not via the wired connection cable 7 but via an infrared wireless network etc., and may also be connected not directly but via a plurality of devices.

Further, the game machine 2 or the unillustrated game cartridge has an unillustrated built-in non-volatile memory for storing necessary pieces of information.

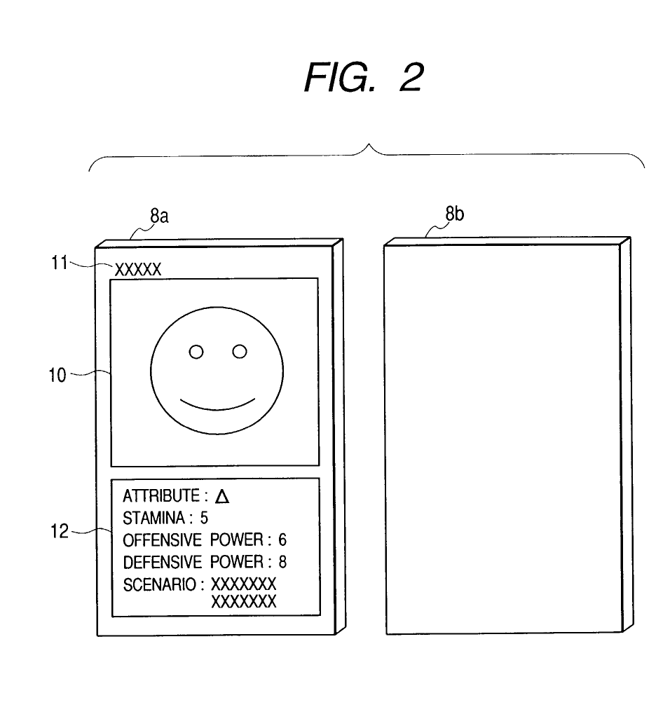

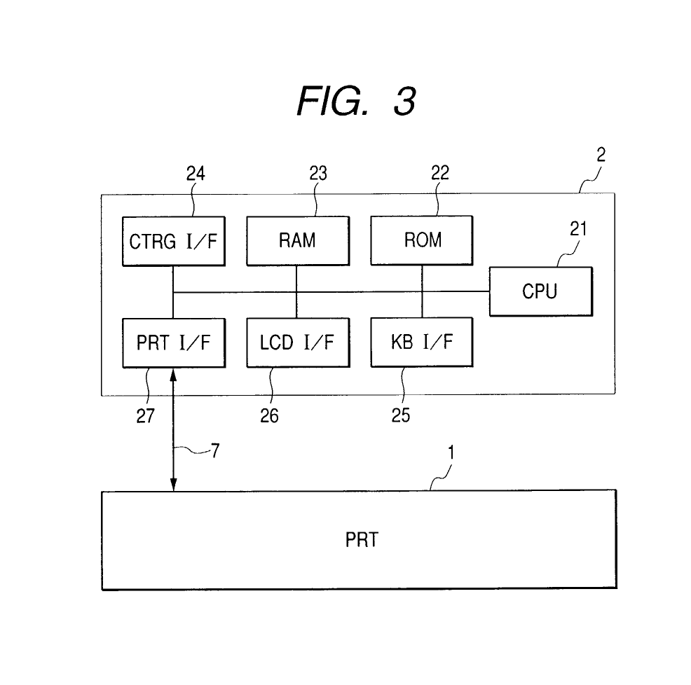

FIG. 2 is a view showing a sample of the card, wherein the output device 1 outputs an image and pieces of information onto the card 8. A symbol 8a represents a card surface. The card surface 8a retains card information (consisting of an image 10, a name 11 and a comment field 12 containing an attribute, stamina, offensive power, defensive power, a game scenario, etc.) of characters of, for instance, a fight type trading game. A symbol 8b designates a card undersurface. Herein, nothing is outputted to the card undersurface 8b so that an image output to the card set in the output device 1 is done just once with “1” as an image output count.

Further, each card herein may have its own independent value of transaction (a different economic value) corresponding to the offensive power, the defensive power etc. described as of the character on the card. Moreover, printing on this card is performed as game software executed by the game machine 2 advances, and a piece of information corresponding to a stage of progress of this game can be printed on the card surface.

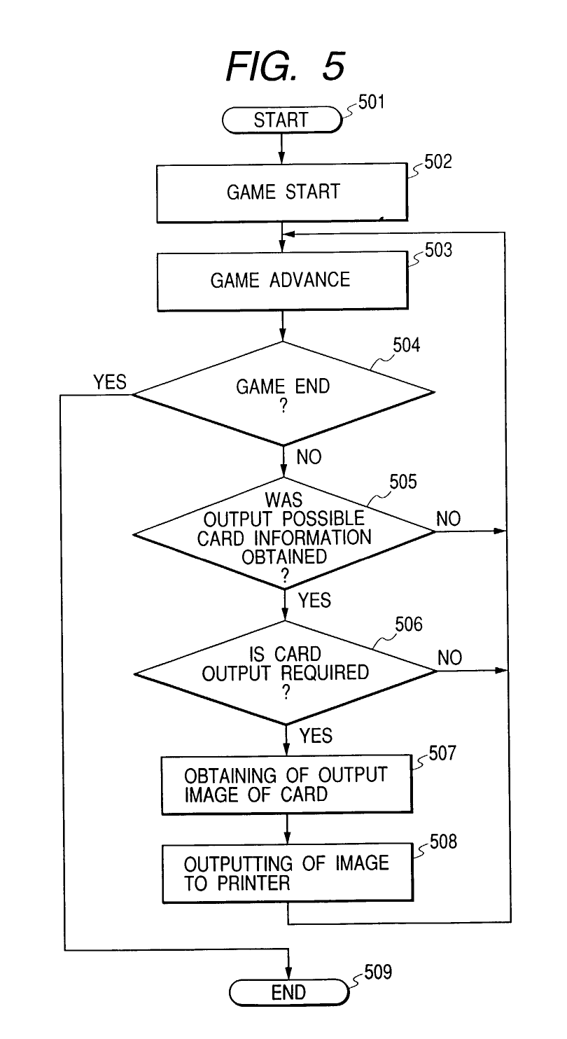

FIG. 3 is a block diagram showing a card game system. A CPU 21 controls operations of the game machine 2 on the basis of programs (including a game program shown in a flowchart in FIG. 5, the card information, the card output images and so forth) stored on a ROM 22. Alternatively, the CPU 21 controls the operations of the game machine 2 on the basis of the programs stored on the storage medium in the game cartridge inserted into the cartridge insert port 4 in a way that reads these programs through a cartridge interface CTRG I/F24. Further, the game program may be temporarily read into an internal RAM 23, and the program on the RAM may also be executed. A keyboard interface KB I/F25 detects inputs of the direction button 5, the decision button 6A, the cancel button 6B, etc. provided on the game machine 2, and transmits the detected information to the CPU 21. A liquid crystal display interface LCD I/F26 displays information required in terms of progress of the game on a liquid crystal display in accordance with the program. A printer interface PRT I/F27 performs communications with the game machine 2 and the output device 1 by use of a wire or wireless connection means (which is the connection cable 7 in FIG. 3). The game machine 2 and the output device 1 perform unidirectional (one way) or bidirectional (both way) communications. The one way communication is that the game machine body 2 transmits the information to the output device 1. The both way communication is that the game machine body 2 receives pieces of information (error processing information (error messages) such as no storage of ink, no storage of paper, a paper jam, etc.) from the output device 1.

Moreover, in the case of the non-volatile memory built in the game cartridge, the CPU 21 reads and writes the information through CTRG I/F24. In the case of the non-volatile memory built in the game machine 2, the CPU 21, based on the assumption that this memory as a non-volatile RAM is included in the RAM 23, reads and writes the information directly from and to the non-volatile memory included in the RAM 23.

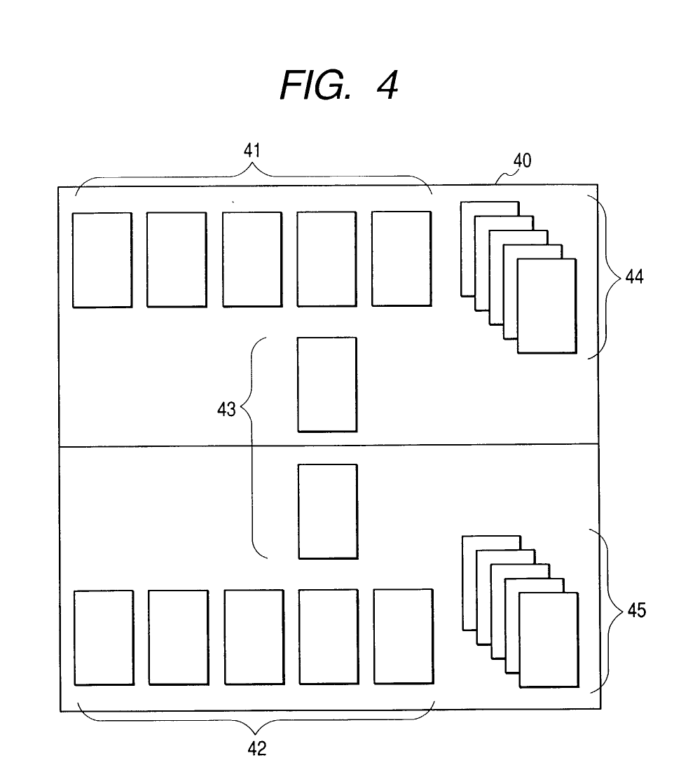

FIG. 4 is a view showing a general gaming method of a physical card game using a group of cards, wherein the card 8 outputted by use of the output device 1 shown in FIG. 2 and commercially available cards are mixed.

A field 40 is a field in which to perform a game using physical materials such as paper, plastics etc., and defines a purpose-by-purpose card position and a deck-of-cards position that will be explained later on. The numeral 44 indicates a deck (which is, e.g., a set of 40 cards) of a player A, and 45 represents a deck (which is similarly a set of 40 cards) of a player B. The numeral 41 denotes a predetermined number of cards (e.g., five cards) in hand, which are drawn by the player A in sequence from the deck 44. The numeral 42 represents a predetermined number of cards in hand, which are drawn by the player B in sequence from the deck 45. Then, each of the players draws one of the cards in hand and displays it with its surface directed to the field 43, thus determining who wins by comparing pieces of card information between the respective cards. Whether the player wins or loses the game is greatly influenced by figuring out a strong deck in a way that considers a combination and a sequence of the cards configuring a deck.

Further, the gaming method performed on the game machine 2 may take such a form as to actualize the same content as the physical card game shown in FIG. 4 on the output device 3, and may also performed in an absolutely different type of game system. This may be, for instance, a general game system known as RPG (role playing game) or an action game system requiring good reflexes. The progress of the game conducted on the game machine 2 is attained in such a way that the CPU 21 of the game machine 2 executes the game program on the basis of key signals of the direction button 5, the decision button 6A and the cancel button 6B. note that the present invention relates to creating the cards through the output device 1m and the operations of the game machine 2 will hereinafter be described in depth with reference to a flowchart in FIG. 5.

FIG. 5 is the flowchart showing the game program (which contains a normal game and involves card output) executed on the game machine 2.

A start of this game program involves inserting the game cartridge for the game machine 2 into the cartridge insert port 4 and is triggered by turning ON an unillustrated power switch.

In step 501, simultaneously with power-ON of the power switch, the CPU 21 reads and starts up the program via the CTRG I/F24. In step 502, the CPU 21 initializes the display unit 3 through the LCD I/F26 and also initializes the game itself, thereby starting the game. Next, the CPU 21 proceeds to step 503 and advances the game corresponding to the inputs from the direction button 5, the decision button 6A and the cancel button 6B through the KB I/F25. The CPU 21 proceeds to step 504, wherein the CPU 21 checks whether the game is ended or not. If the end of the game is selected, the processing goes to step 509, wherein the game ends. Alternatively, the game falls into a forced termination by turning OFF the unillustrated power switch.

If the game is not ended, the processing proceeds to step 505. Herein, the CPU 21 judges whether there is obtained the card information that can be outputted during the game. If possible-of-output card information is not obtained, the CPU 21 loops back to step 503 and continues a progress of the normal game. If the possible-of-output card information is obtained, the CPU 21 proceeds to step 506, wherein the CPU 21 displays on the display unit 3 a query about whether the card output is required, and prompts the player to select any one of “YES” and “NO” by use of the direction button 5. Then, a content of the selection is decided by pressing the decision button 6A. In this case, it may be considered the same as a meaning of selecting “NO” that the cancel button 6B is pressed.

Herein, (the possible-of-output card information) is defined as information for specifying, when outputting an image from the output device as will be explained later on, this image, and can be generated by, to be specific, in the game program, an occurrence of an event containing this item of information as attached information under a predetermined condition during an execution of the game program. The possible-of-output card information can be stored on the memory incorporated into the cartridge.

If “NO” is selected in step 506, the CPU 21 diverts to step 503 and continues the progress of the normal game.

Whereas if “YES” is selected in step 506, the CPU 21 proceeds to step 507 and obtains through the CTRG I/F24 a card output image retained in the game cartridge and corresponding to the possible-of-output information concerned. In this case, the whole output image of the card may be all retained on the game cartridge, or while retaining only the image information required at the minimum, the game machine 2 may synthesize and configure the output images based on the various categories of digital card information (consisting of the image 10, the name 11 and the comment field 12 containing the attribute, the stamina, the offensive power, the defensive power, the game scenario, etc.). After obtaining the image information that should be outputted in step 507, the CPU 21 proceeds to step 508. In step 508, the CPU 21 executes outputting of the card 8 by transmitting the output image to the output device 1 through the connection cable 7 from the PRT I/F27. Then, upon finishing the card output, the CPU 21 loops back to step 503 and continues the progress of the normal game.

Thereafter, it follows that the normal game proceeds and the card output is repeated corresponding to the state of acquisition of the possible-of-output cad information till the end of the game is selected in step 504. In the way described above, the cards usable for the physical card game ca be outputted from the game machine 2 through the output device 1 by synchronizing the card output with the progress of the normal game performed on the game machine 2. At this time, a scheme of obtaining the card information that can be outputted in the normal game performed on the game machine 2, makes it possible to give a tight interlocking characteristic between the normal game and the card game.

The possible-of-output card information can be predetermined in the game program so that the same information is generated if a predetermined condition occurs as the game progresses.

To give one example, a variety of opponent and allied characters appear in the process till reaching a final target in the general RPG (role playing game). Among those characters, there are some characters each performing a very important role in the story and impressed on a memory of the user. In this case, when such a character appears for the first time in the normal game and on other occasions, the game program can be designed to output a card corresponding to this character.

With this design, the card can be outputted synchronizing with the progress of the normal game, and hence a new criterion such as (a stage of progress of the normal game) can be incorporated into a card transaction value (different economic value) setting/providing method.

Further, there is given a design in which a plurality of final targets themselves are set and all the targets can not be cleared in one single game play, and the program is designed so that the possible-of-output card information is generated to enable the card outputs each different for every target, whereby a further diversity can be given to the card transaction value. Further, the same effect can be expected by preparing a plurality of processes reaching the final target as well as preparing the plurality of final targets. Still further, as a secondary effect, a desire for and a sense of attainment of clearing the normal game can be improved by providing a physical result as definite as the card output.

The effects described above are not necessarily limited particularly to the RPG (role playing game), and the present invention can be, as a matter of course, applied to whatever categories, for example, an adventure game, an action game and so on.

As described above, the game software controls the print content and the print timing in accordance with the stage of progress of the game and outputs the card, whereby the virtual game performed on the game machine can be organically interlinked to the physical game. This leads to an increase in enjoyment of the whole game and to an expectation of an effect of creating a new added-value of the card to be outputted.

(Second Embodiment)

The first embodiment has exemplified the case of outputting the card in the process of the progress of the normal game. Especially the portable game machine etc., however, has a high possibility of performing the game somewhere the players go out, and in this case it is not so realistic that the card is outputted by connecting the output device 1 each time. It is therefore desirable that the step of obtaining the possible-of-output card information and the step of actually executing the card output be provided separately.

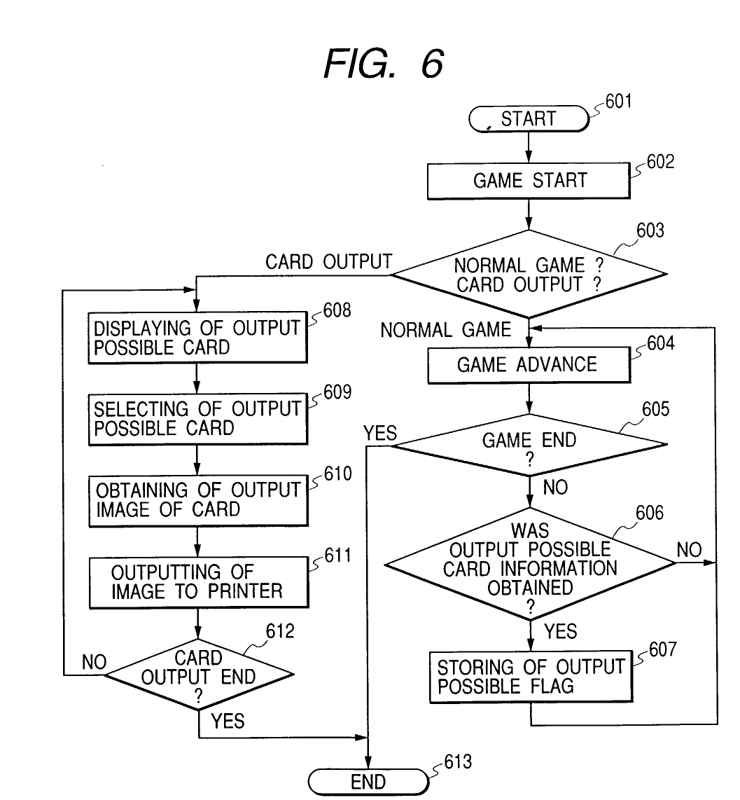

FIG. 6 shows a flowchart of a game program (which contains a normal game and involves card output) executed on the game machine 2.

This game program is started when the player inserts the game cartridge for the game machine 2 into the cartridge insert port 4 and turns ON an unillustrated power switch.

In step 601, simultaneously with power-ON of the power switch, the CPU 21 reads and starts up the program via the CTRG I/F27. In step 602, the CPU 21 initializes the display unit 3 through the LCD I/F26 and also initializes the game itself, thereby starting the game. Next, the CPU 21 proceeds to step 603 and prompts the user to select a progress of the normal game or an execution of the card output. Herein, as in step 506 according to the embodiment 1, the display unit 3 displays choices of desiring for the progress of the normal game and desiring for the card output, wherein any one of the (normal game) and the (card output) is selected by the direction button 5f, and a content of the selection is decided by pressing the decision button 6A.

If the normal game is selected in step 603, the CPU 21 proceeds to step 604, in which the normal game proceeds. Then, the CPU 21 goes to step 605 and checks whether the game is terminated or not. If the end of the game is selected, the CPU 21 diverts to step 613 and terminates the game. Alternatively the game falls into a forced termination by turning OFF the unillustrated power switch.

If the game is not terminated, the CPU 21 goes to step 606 and judges whether there is obtained the card information that can be outputted during the game. If the possible-of-output card information is not obtained, the CPU 21 proceeds to step 604 and continues a progress of the normal game.

If the possible-of-output card information is obtained, the CPU 21 proceeds to step 607, and sets and stores a flag indicating that this card can be outputted. At this time, the CPU 21 may notify the user that the possible-of-output card information is obtained in a way that displays this purport on the display unit 3 as the necessity arises. A storage location of this flag involves the use of an unillustrated storage medium within the game cartridge inserted into the cartridge insert port 4, and the CPU 21 stores the flag through the CRTG I/F24. Then, upon an end of setting and storing the flag, the CPU 21 loops back to step 604 and continues the progress of the normal game.

If the card output is selected in step 603, the CPU 21 diverts to step 608. In step 608, the CPU 21 reads the possible-of-output card flag set and stored in step 607 through the CTRG I/F24, and displays the possible-of-output card on the display unit 3. Next, the CPU 21 goes to step 609, wherein one or a plurality of cards that the user desires to output are selected and decided by use of the direction button 5 and the decision button 6A. After selecting the desire-to-output cards, the CPU 21 proceeds to step 610 and obtains output images of the cards corresponding to the selected cards through the CTRG I/F24, which are retained in the game cartridge. When the image information that should be outputted is obtained in step 610, the CPU 21 proceeds to step 611. In step 611, the card 8 is outputted by transmitting the output image to the output device 1 via the connection cable 7 from the PRT I/F27. Then, upon finishing the card output, the processing proceeds to step 612, wherein the CPU 21 displays on the display unit 3 a query about whether the card output is terminated, and prompts the user to make a choice by use of the direction button 5 and the decision button 6A. If “NO” (which means a continuation of the card output) is selected in step 612, the processing loops back to step 608, wherein the possible-of-output card is again displayed, and the card is selected and outputted in the way which follows.

If “YES” (which means a termination of the card output) is selected in step 612, the processing goes to step 613 and comes to an end.

The processing ends with step 613 in the second embodiment, however, if a desire is to an alternately continuous execution of the progress of the normal game and the card output, the processing does not come to the end in step 613 but loops back to step 603, wherein the CPU 21 again prompts to the user select the progress of the normal game or the card output, thus enabling a smooth progress on the whole. The smooth progress as a whole can be attained otherwise, wherein if the cancel button 6B is pressed when selecting the possible-of-output card in step 609, the processing is made to go back to step 602. These improved schemes, however, deviate from the gist of the present invention and are therefore omitted.

The second embodiment of setting and storing the possible-of-output card flag during the progress of the normal game and executing the card output based on the content of the stored flag, in addition to the effects of the first embodiment, eliminates the necessity for the output device 1 to exist closely at all times during the progress of the normal game and enables the operations more suited to the portable game machine.

Note that there is no necessity of adopting exclusively any one of the methods in the first and second embodiments, and a multiplex operation of these methods can support a much smoother progress of the game for the user. For instance, if the possible-of-output card information is obtained, the user may select whether the card output is executed immediately or later on, or the possible-of-output flag may also be set irrespective of whether the card is outputted immediately or not.

(Third Embodiment)

According to a third embodiment, the card information is transmitted to an installed type output control unit under the control of the game software.

Especially in the market of the portable game machines, it is not so realistic in terms of matching with the portability that each game machine is equipped one by one with the card output device.

A preferable mode in this case is that the installed type card output device and the output control unit thereof are disposed at, e.g., a convenience store etc., the card information is transmitted via a cable or wirelessly from the portable game machine, and the installed type card output device outputs the card corresponding to the card information.

In this case, the out put control unit and the installed-type card output device may be integral with each other, or may also be separated from each other and connected via a cable or wirelessly.

With this contrivance, each individual user may not hold the card output device. Further, generally the games for the portable game machine are supplied in an as-installed-into-ROM-cassette state in the great majority of cases, and this storage capacity is s smaller than DVD, CD-ROM and GD-ROM media in the installed-type game machine. Moreover, generally a large proportion of the portable game machines have lower throughputs than those of the installed-type game machines. Hence, the system is configured so that the information related to the card output is retained as much as possible on the output control unit and the card output device, while the game machine may only transmit a minimum amount of card information, whereby the system can be operated most effectively.

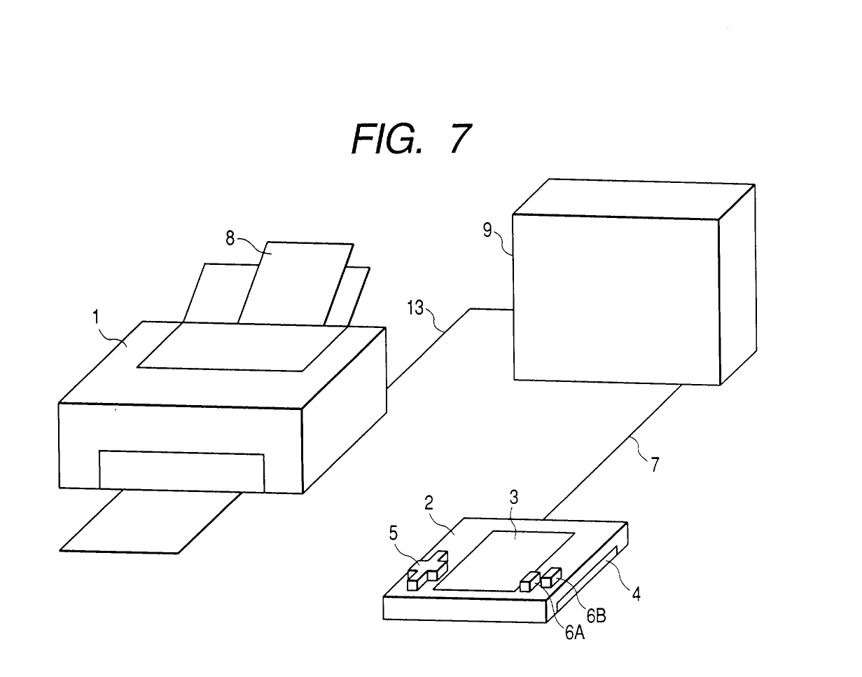

FIG. 7 is an explanatory system view showing an architecture of the card game system in the third embodiment.

The output device 1, the game machine 2, the display unit 3, the game cartridge insert port 4, the direction input button 5, the decision button 6A and the cancel button 6B, are the same as those shown in FIG. 1 in the first embodiment. An output control device 9 is connected to the game machine 2 via the connection cable 7. The output control device 9, based on the information sent from the game machine 2, obtains and generates the card output information, and records a desired item of card information on the card 8 from the output device 1 via the connection cable 13.

Herein, the discussion will be focused on a system for outputting the card by using the output device 1 via the connection cable 7, the output control device 9 from the portable game machine 2 using the game cartridge. Unless specified otherwise, however, if premised that the functions of the present invention can be executed, the connection between the game machine 2 and the output control device 9 and the connection between the output control device 9 and the output device 1 may be attained not by the connection cables 7, 13 but by an infrared wireless network, and may also be attained not by the direction connections but via a plurality of devices. Further, the output control device 9 and the output device 1 may not be necessarily constructed separately and connected via the cable, and may also be constructed into one united body.

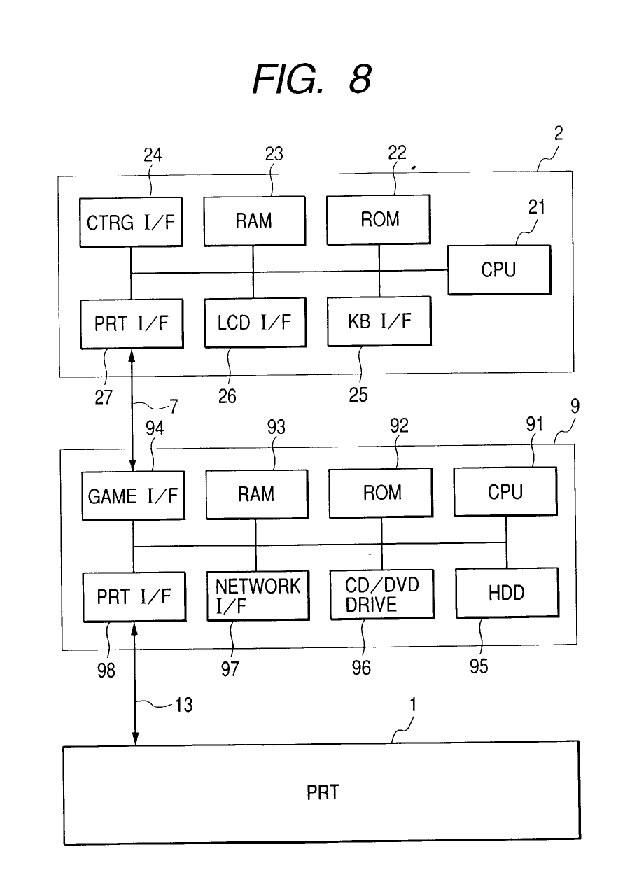

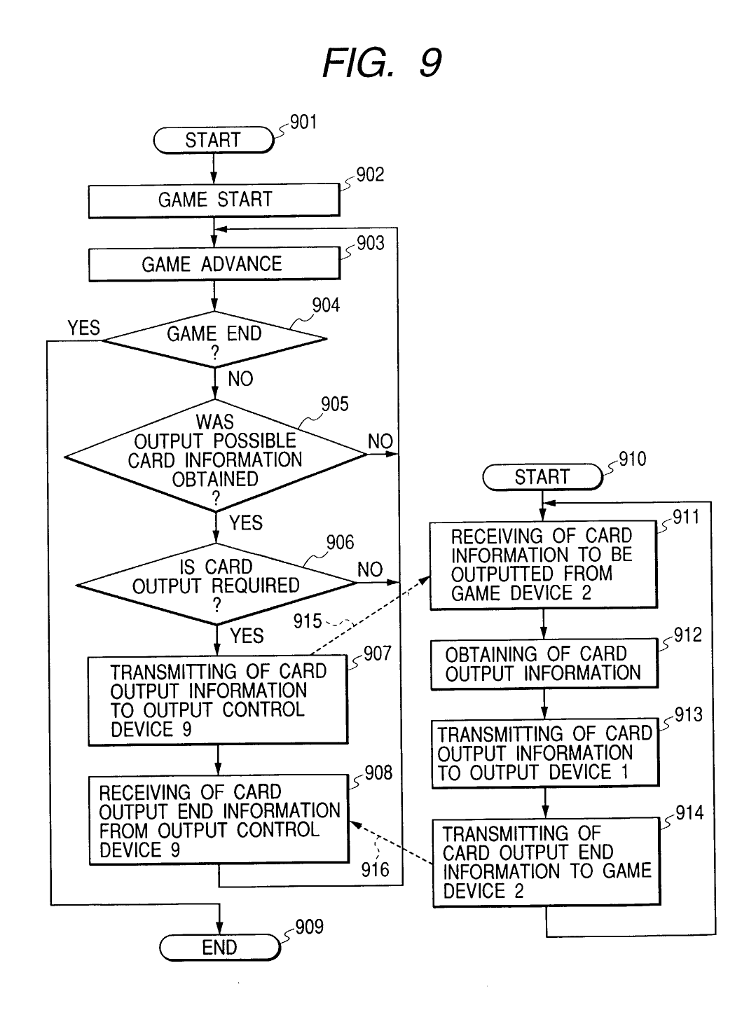

FIG. 8 is a block diagram showing the card game system in the third embodiment. A CPU 21, a ROM 22, a RAM 23, a CTRG I/F24, a KB I/F25 and an LCD I/F26 in the game machine 2 are the same as those in FIG. 3 in the first embodiment. The PRT I/F27 is connected to the output control device 9 via the connection cable 7 and transfers the information such as the card information etc. outputted through the one-way or both-way communications. A CPU 91 controls the operations in the output control device 9 on the basis of programs (including a game program shown in a flowchart in FIG. 9, the card information, the card output images and so forth) stored on a ROM 92 or an HDD 95. Alternatively, the CPU 91 controls the operations of the output control device 9 on the basis of the programs stored on the storage medium such as a CD or a DVD etc. set in a CD/DVD DRIVE 96 in a way that reads these programs through the CD/DVD DRIVE 96. Further, the game program may be temporarily read into an internal RAM 93, and the program on the RAM 93 may also be executed. Moreover, the game program stored thereon and the card output information may be downloaded over the network via a NETWORK I/F97.

A GAME I/F94 is connected to the game machine 2 via the connection cable 7, and performs the one-way or both-way communications with the game machine, thus transferring the information such as the card information etc. to be outputted. A PRT I/F98 (printer interface) transfers the information between the output control device 9 and the output device 1 by use of a cable or wireless connection means (which is the connection cable 7 in FIG. 8). The one-way or both-way communications between the output control device 9 and the output device 1 are carried out. When performing the one-way communication, the information from the output control device 9 is transmitted to the output device 1. When performing the both-way communications, in addition to the transmission described above, the output control device 9 receives pieces of information (error processing information such as no storage of ink, no storage of paper, a paper jam etc.) from the output device 1. The output control device 9 transfers the information received from the output device 1 to the game machine 2 as the necessity arises. Alternatively, the game machine 2 may be connected directly to the output device 1.

FIG. 9 is a flowchart showing a game program (which contains the normal game and involves the card output) running on the game machine 2 and the output control device 9 in the third embodiment. A program module consisting of steps 901 through 909 on the left side in FIG. 9 is executed inside the game machine 2. A program module consisting of steps 910 through 914 on the right side in FIG. 9 is executed inside the output control device 9. Dotted lines 915 and 916 in FIG. 9 indicate information transmitted and received between the game machine 2 and the output control device 9 via the connection cable 7.

To start with, the output control device 9 is kept in a standby status till it receives the output card information from the game machine 2 in step 911 after the CPU 91 has started up an internal program of the HDD 95 simultaneously with power-ON of the power switch in step 910.

The game program for the game machine starts when the player inserts the game cartridge for the game machine 2 into the cartridge insert port 4 and turns ON an unillustrated power switch.

In step 901, simultaneously with power-ON of the power switch, the CPU 21 reads and starts up the program via the CTRG I/F24. In step 902, the CPU 21 initializes the display unit 3 through the LCD I/F26 and also initializes the game itself, thereby starting the game. Next, the CPU 21 proceeds to step 903 and advances the game corresponding to the inputs from the direction button 5, the decision button 6A and the cancel button 6B through the KB I/F25. The CPU 21 proceeds to step 904, wherein the CPU 21 checks whether the game is ended or not. If the end of the game is selected, the processing goes to step 909, wherein the game ends. Alternatively, the game falls into a forced termination by turning OFF the unillustrated power switch.

If the game is not ended, the processing proceeds to step 905. Herein, the CPU 21 judges whether there is obtained the card information that can be outputted during the game. If the possible-of-output card information is not obtained, the CPU 21 loops back to step 903 and continues a progress of the normal game. If the possible-of-output card information is obtained, the CPU 21 proceeds to step 906, wherein the CPU 21 displays on the display unit 3 a query about whether the card output is required, and prompts the player to select any one of “YES” and “NO” by use of the direction button 5. Then, a content of the selection is decided by pressing the decision button 6A. In this case, it may be considered the same as a meaning of selecting “NO” that the cancel button 6B is pressed. If “NO” is selected in step 906, the CPU 21 diverts to step 903 and continues the progress of the normal game. Whereas if “YES” is selected in step 906, the CPU 21 proceeds to step 907.

In step 907, the game machine 2 transmits output card information 915 to the output control device 9 via the connection cable 7. Then, the output control device 9 receiving the output card information 915 goes to step 912, wherein the CPU 91 obtains output image data of the card corresponding to the possible-of-output card information that is stored on the HDD 95, and generates an output image thereof. In this case, the whole output image of the card may be stored on the HDD 95, or while retaining only the image information required at the minimum, the output control device 9 may synthesize and configure the output images based on the various categories of digital card information (consisting of the image 10, the name 11 and the comment field 12 containing the attribute, the stamina, the offensive power, the defensive power and the game scenario). After obtaining and generating the image information that should be outputted in step 907, the processing proceeds to step 908. In step 908, the card 8 is outputted by transmitting the output image to the output device 1 through the connection cable 13 from the PRT I/F98. Then, upon finishing the card output, the processing goes to step 909, wherein card output end information 916 is transmitted to the game machine 2. After finishing the transmission of the card output end information 916, the processing proceeds to step 911 and reverts to a standby status for waiting a next piece of output card information 915.

The game machine 2 receiving the card output end information 916 in step 908 loops back to step 903, and continues the normal game. Thereafter, till the end of the game is selected in step 904, it follows that the card output is repeated corresponding to the progress of the normal game and the state of obtaining the possible-of-output card information.

As described above, the output control device 9 receives the output card information from the game machine 2, and obtains and transmits the real card output information to the output device 1, and the output device 1 outputs the card, whereby there is eliminated the necessity of retaining all the card output information on the game machine 2, and there is improved a degree of freedom in terms of interlinking the actual game performed on the portable game machine to the card playing game using the outputted cards.

The third embodiment has exemplified the system in which the output control device 9 executes outputting the cards on the basis of the first embodiment. In this case, however, when actually obtaining the card that can be outputted on the portable game machine, the game machine must be connected to the output control device 9 each time, and the cards must be outputted sheet by sheet. Further, if the output control device 9 does not exist nearby, the user is forced to select the progress of the game by choosing “NO” in response to the query about the card output or a stop of the progress of the game till the output control device 9 is connected.

Such being the case, the problem described above can be improved based on the second embodiment, wherein the output device 9 outputs the cards. The progress of the game is not stopped only by setting a possible-of-output card flag during the game. Then, when the user actually connects the output control device 9 to the game machine 2, the possible-of-output card is actually outputted by selecting the card output. With this scheme, a much smoother progress of the game can be actualized.

As in the discussion on the second embodiment, there is no necessity of exclusively adopting the example based on the first embodiment and the example based on the second embodiment, and the even smoother progress of the game can be attained by executing a multiplex operation thereof.

Further, new cards with a new design can be always provided by periodically updating the contents on the HDD 95 in the output control device 9. Normally, pieces of CD-ROM formatted and ROM cassette formatted game software are, if once sold, very hard to add functions and cards thereafter. If using the output control device 9 according to the present invention, however, the ever-updated cards can be outputted by use of the HDD 95 or CD/DVD DRVE 96 and further by downloading via the NETWORK I/F97.

(Fourth Embodiment)

A characteristic of a fourth embodiment is that even when the same output card information is inputted from the game machine, this item of output card information is given a difference from the card output information transmitted to the output device 1 from the installed-type output control unit. For example, a card having a design that differs area by area in place and a card processed so that a parameter differs when outputted for a given period of time, can be used as rare cards (each exhibiting a scarcity value). This is a means for providing the rare cards.

A system architecture of the card game system explained in the fourth embodiment is the same illustrated in FIG. 7. The names and operations of the respective components are the same as those described in the second embodiment.

FIG. 8 also shows a block diagram of the card game system in the fourth embodiment. The names and operations of the respective components are the same as those explained in the second embodiment.

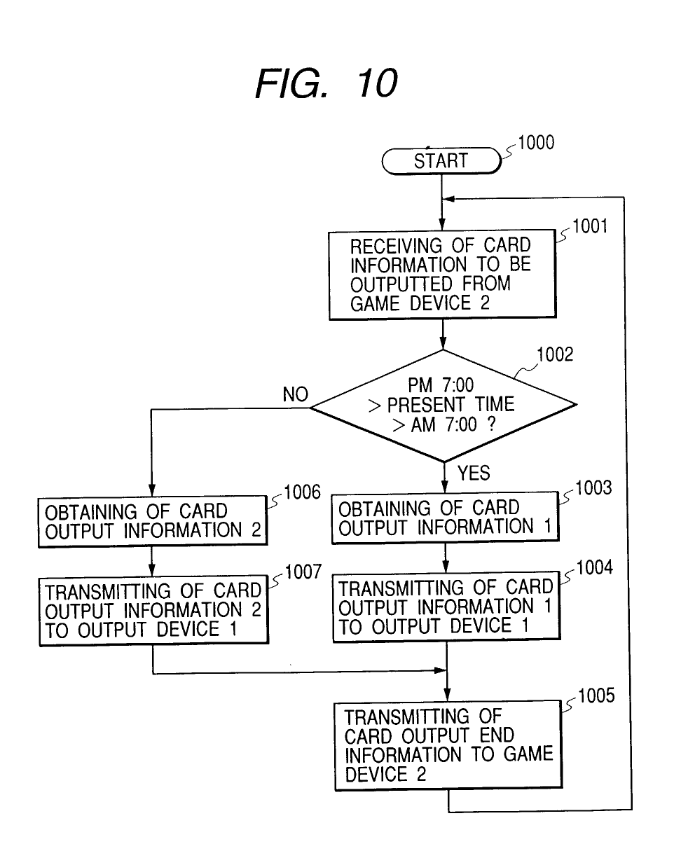

FIG. 10 is a flowchart showing a program executed by the output control device 9 in the fourth embodiment. The operations executed on the side of the game machine 2 are the same as those in the third embodiment.

To begin with, the output control device 9 is kept in a standby status till it receives the output card information from the game machine 2 in step 1001 after the CPU 91 has started up an internal program of the HDD 95 simultaneously with power-ON of the power switch in step 1000. Upon receiving the output card information via the connection cable 7 from the game machine 2, the output control device 9 proceeds to step 1002. In step 1002, the CPU 91 obtains the present time from an unillustrated internal clock in the output control device 9, and compares the present time with a predetermined period of time (from seven o'clock in the morning through seven o'clock in the night in FIG. 10). If judged to be “YES” in step 1002, the output control device 9 proceeds to step 1003, wherein card output information 1 corresponding to the card information is obtained and generated from the HDD 95. Then, processing goes to step 1004, wherein the card output information 1 is transmitted to the output device 1 via the connection cable 13. Upon an end of the transmission, the output control device 9 proceeds to step 1005, in which the output end information is transmitted to the game machine 2 via the connection cable 7. Thereafter, the output control device 9 loops back to step 1001, the output control device 9 comes to again the standby status till it receives the output card information from the game machine 2.

If a result of making the time-comparison in step 1002 is “NO”, the output control device 9 diverts to step 1006. In this case, card output information 2 different from the card output information 1 corresponding to the card information, is obtained and generated from the HDD95. Then, the output control device 9 proceeds to step 1007, and transmits the card output information 2 to the output device 1 via the connection cable 13. Upon finishing the transmission, the output control device 9 diverts to step 1005 and transmits the output end information to the game machine 2 via the connection cable 7. Thereafter, the output control device 9 loops back to step 1001 and again comes to the standby status till it receives the output card information from the game machine 2.

As discussed above, even when the same output card information is sent from the game machine, the output control device 9 selects one piece of card output information from among the plurality of different pieces of card output information in accordance with the predetermined condition, and thus obtains and generates the card output information, thereby making it possible to provide the new rare card generating means.

According to the fourth embodiment, the (present time) is used as the predetermined condition, however, the fourth embodiment is not necessarily limited to the (present time) as the predetermined condition and may give differences to the pieces of card output information outputted based on conditions such as other time factor (e.g., a period of time from the start of the game), a geometrical condition (e.g., a place where the game is performed), a machine ID of the game machine), a product number (a serial number of the software), a random element, a date an so on.

Further, in addition to giving the difference to the card information itself to be outputted, there may be taken a scheme that the output is permitted if a predetermined condition is met but is not permitted in other cases. Another scheme is that one of the choices such as plural types of outputs and non-permissions is taken based on the predetermined condition.

(Fifth Embodiment)

A fifth embodiment is contrived so that the card readable by the game machine is outputted under the game software.

In addition to the embodiments discussed above, the inter-linkage between the game machine and the card game can be strengthened by outputting the card containing, e.g., bar codes readable by the game machine when printing the card.

Further, if a developed form is taken, wherein information on a character A changes by putting the character A into processes such as card outputting→card reading with the result that the changed information is registered as, e.g., a different character B, this scheme can stimulates a new curiosity of the user. Then, a chain of curiosities of the user may arise in such a way that the user gets curious to know “what change will occur if effecting the card outputting→card reading with respect to the character B”, and so forth.

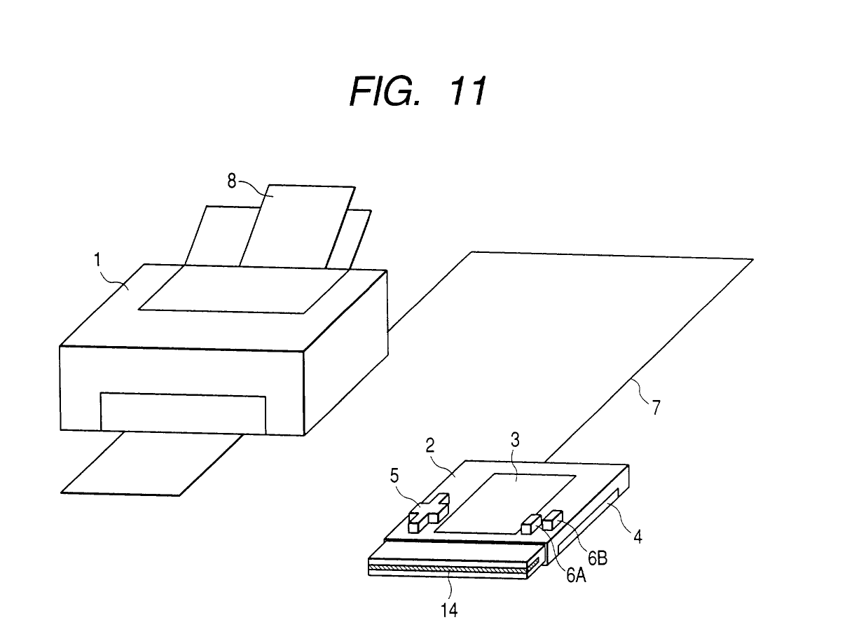

FIG. 11 shows an explanatory system view of a system architecture of the card game system in the fifth embodiment. The names and operations of the respective components 1 through 8 in FIG. 11 are the same as those explained in FIG. 1 in the first embodiment. A reader 14 transmits the information recorded on the card 8 to a reading game machine 2.

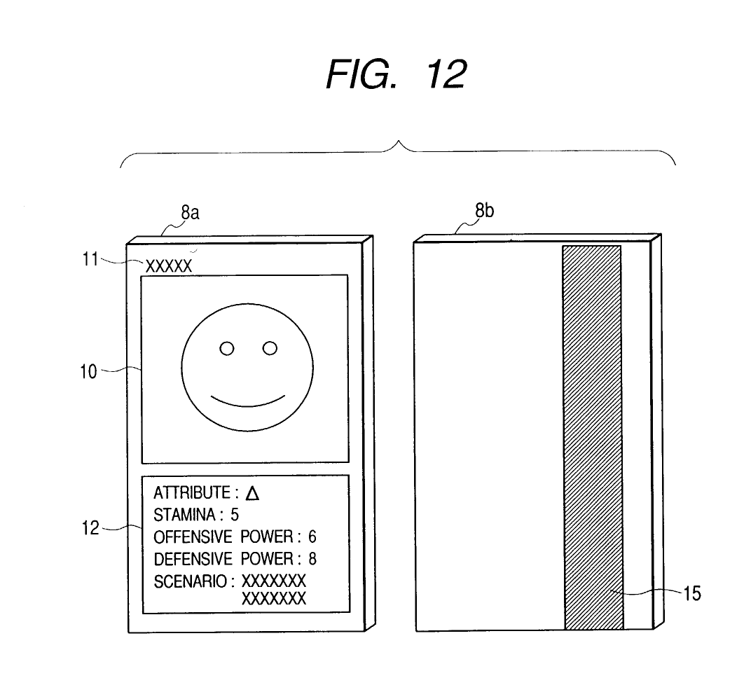

FIG. 12 is a view showing a sample of the card of which an image and pieces of information are outputted onto the card 8 by the output device 1. A card surface 8a is the same as that in FIG. 2 in the first embodiment. The symbol 8b represents a card undersurface on which, for instance, a character identifying information is stored on a magnetic tape 15. The card is composed of paper as in the case of the prior art, and the character identifying information (ID) required at the minimum is stored on the magnetic tape 15 or unillustrated bar codes on the undersurface thereof, whereby a card manufacturing cost can be restrained.

Moreover, the creation of the card and the recording on the bar codes are carried out simultaneously through one outputting process, and therefore the unillustrated bar codes may be formed on the card surface 8a.

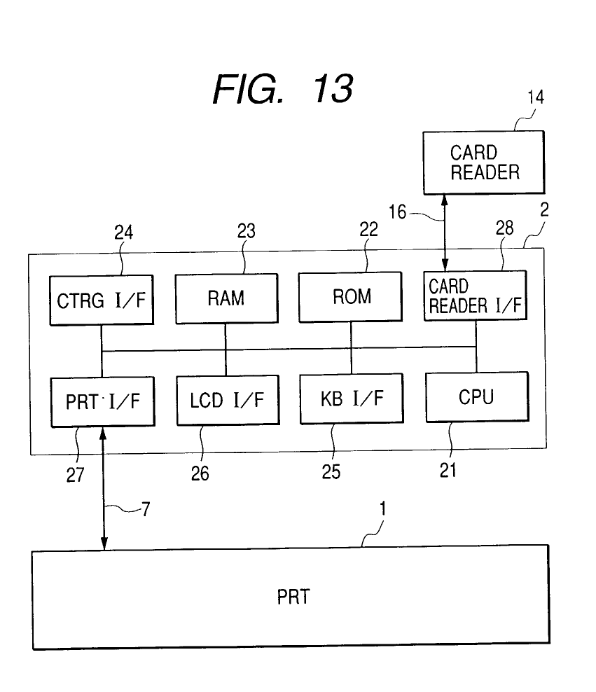

FIG. 13 is a block diagram showing the card game system in the fifth embodiment. The names and operations of the respective components 1 through 7 and 21 through 27 are the same as those explained in FIG. 3 in the first embodiment. A card reader interface CARD READER I/F28 is connected to the reader 14 via an unillustrated connecting means 16, and receives a content read by the reader 14.

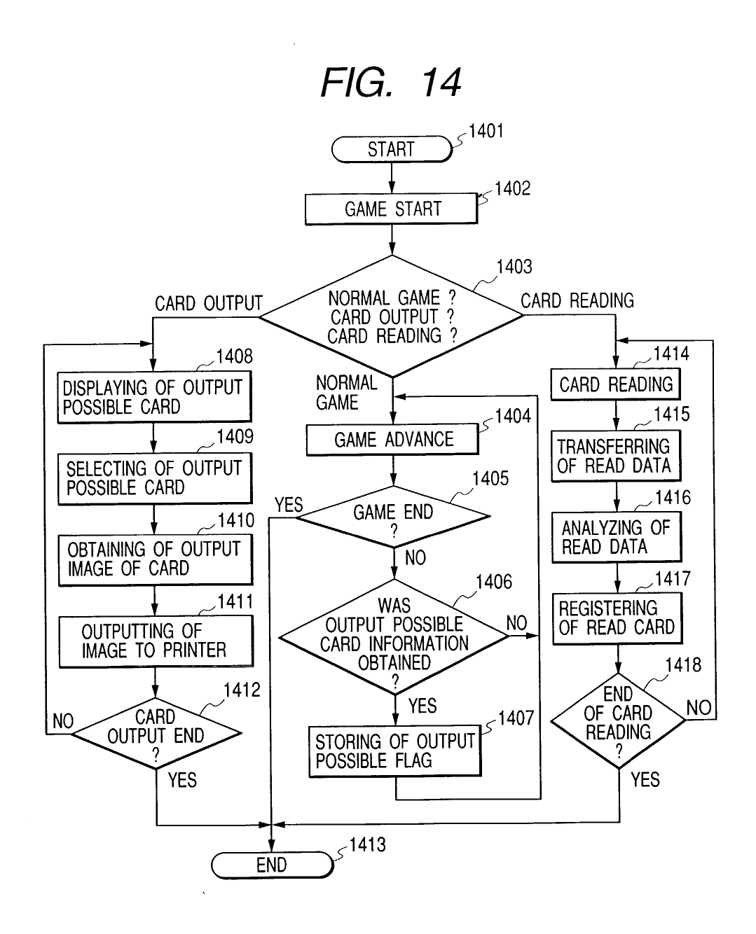

FIG. 14 is a flowchart of a program executed on the game machine 2 in the fifth embodiment. Steps 1401 through 1413 correspond to steps 601 through 613 in FIG. 6 in the second embodiment.

More choices for (card reading) than in step 603 are given in step 1403. Herein, if (card reading) is selected, the processing diverts to step 1414. In step 1414, the reader 14 reads the card information stored on the card 8. Next in step 1415, the thus read information is transferred to the game machine 2 via the unillustrated connecting means 16 from the reader 14. Then, the processing proceeds to step 1416, wherein the CPU 21 analyzes the card information transferred, and confirms the card content. In step 1417, the confirmed card is registered so that the card can be used on the game machine 2, when finishing the reading and registration of the card, the processing goes to step 1418, wherein it is confirmed whether the card reading is to be terminated or not. Herein, if “YES” is selected, the processing proceeds to step 1413. Whereas if “NO” is selected, the processing loops back to step 1414, wherein the card reading again continues.

Herein, if step 1413 is not set as the (END) step, the processing returns to step 1401 so prompt the user to select any one of (normal game), (card output) and (card reading), thereby making the progress of the game much smother.

As discussed above, the system has both of the card reading function and the card outputting function, whereby the card output can be executed based on the read card and a new interest can be provided to the user. For instance, a different piece of card information from the card information used for recording the card A, is recorded on the card A, and the card A can be also registered as a different card in the case of reading this card A.

Further, the reading function is added to the output control device 9 in the fourth embodiment, there by eliminating the necessity of adding the reader to all of the portable game machines. In this case also, the rare card providing means as described in the fourth embodiment can be applied, and the different card information can be generated even in the case of executing the reading process at a specified time and so on.

(Sixth Embodiment)

Some of the first through fifth embodiment do not inhibit whatever sheets of the same cards from being outputted by repeating the same process (such as an event of obtaining the possible-of-output card, and so on) a plurality of times. If done so, the scarcity value of the card declines.

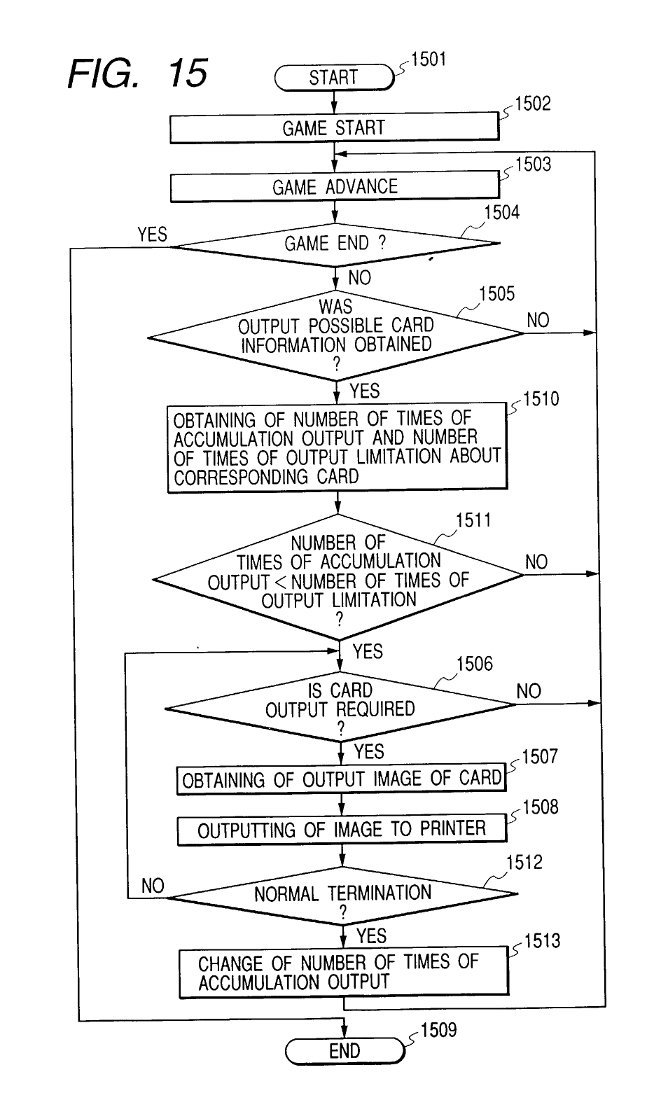

FIG. 15 is a flowchart showing a game program (which contains the normal game and involves the card output) executed on the game machine 2 in the sixth embodiment. Steps 1501 through 1509 show the same operations as those conducted in steps 501 through 509 in FIG. 5. In step 1510, an accumulation output cunt of the card concerned is read from the nonvolatile memory. Further, the number of times of output limitations (which will hereinafter be simply termed “an output limitation count”) of the card concerned is obtained from the ROM 22 or the game cartridge. In step 1511, the number of times of accumulation outputs (which will hereinafter be simply termed “an accumulation output count”) is compared with the output limitation count, and, if the accumulation output count is less than the output limitation count, the processing returns to step 1503, wherein the normal game continues its progress.

If the card is outputted through steps 1506, 1507, 1508, it is next confirmed in step 1512 whether a card output by the output device 1 is normally finished. If the card output can not come to the normal end for some reason (no storage of paper, no storage of paper, and an unexpected fault such as a power failure etc.), the processing loops back to step 1506, wherein it is again confirmed whether the card output is carried out or not.

If the card output comes to the normal end in step 1512, the processing proceeds to step 1513, in which the accumulation output count is changed. Normally, the accumulation output count is incremented by 1 and thus saved on the non-volatile memory. Then, the processing returns to step 1503, in which the progress of the normal game continues.

As described above, the output count can be restricted by saving the accumulation output count on the non-volatile memory. Hence, if the output limitation count is set to, e.g., 1, and if card output is done once even when the same process (such as an event of obtaining the possible-of-output card, and so on) is repeated any number of times, the card output is restricted so that the output can not be implemented from next time onward. Therefore, the scarcity value of the card can be kept.

Further, the method of keeping the scarcity value according to the present invention is not limited to the method exemplified in the embodiment discussed above, and the present invention may take whatever methods if configured to obtain the effects of the present invention. For example, there may be adopted a method of storing on the non-volatile memory, for instance, a (remaining possible-of-output card count) as a substitute for the (accumulation output count/possible-of-output count).

Moreover, the card output timing is not limited to within the game, and there may be adopted a system in which a possible-of-output flag is just set during the game, and the card output can be effected any time later on. In this case, the plurality of cards can be outputted more easily, and it is therefore desirable that the output count restriction according to the present invention be effected.

Further, the card output and a timing for correcting the accumulation output count are much of importance. If the accumulation output count is corrected before executing the card output, for example, when the power supply of the game machine 2 is switched OFF before the card output is completely finished, the accumulation output count is to be changed, however, there is a high possibility in which the perfect card can not be outputted. Then, even when trying to output the same card, the accumulation output count has already been corrected, and hence a possibility is that the output can not be permitted any more.

To prevent this state, as explained in the sixth embodiment, it is desirable that the accumulation output count be corrected after confirming that the card output has normally been finished.

(Seventh Embodiment)

In a seventh embodiment, a possibility-of-plural-outputs flag is provided for every card. Alternatively, in the case of the card of which a possible-of-plural-outputs flag is set ON, a plurality of outputs can be done. In the case of the card of which this flag is set OFF, the plurality of outputs can not be done. This scheme makes it feasible to build a relationship such as the possible-of-plural-outputs card=the card exhibiting a low scarcity value, and the impossible-of-plural-outputs card=the card exhibiting a high scarcity value.

FIG. 1 shows the explanatory system view showing an architecture of the card game system in the seventh embodiment. The names and operations of the respective components are the same as those explained in the first embodiment.

FIG. 3 shows a block diagram of the card game system in the seventh embodiment. According to the seventh embodiment, the ROM 22 or the game cartridge is stored with a piece of possible-of-outputting-plural-sheets information indicating whether a permission of outputting of a plurality of sheets is given to each card. Further, the non-volatile memory retains a piece of already-outputted information indicating whether the output for every card has already been done.

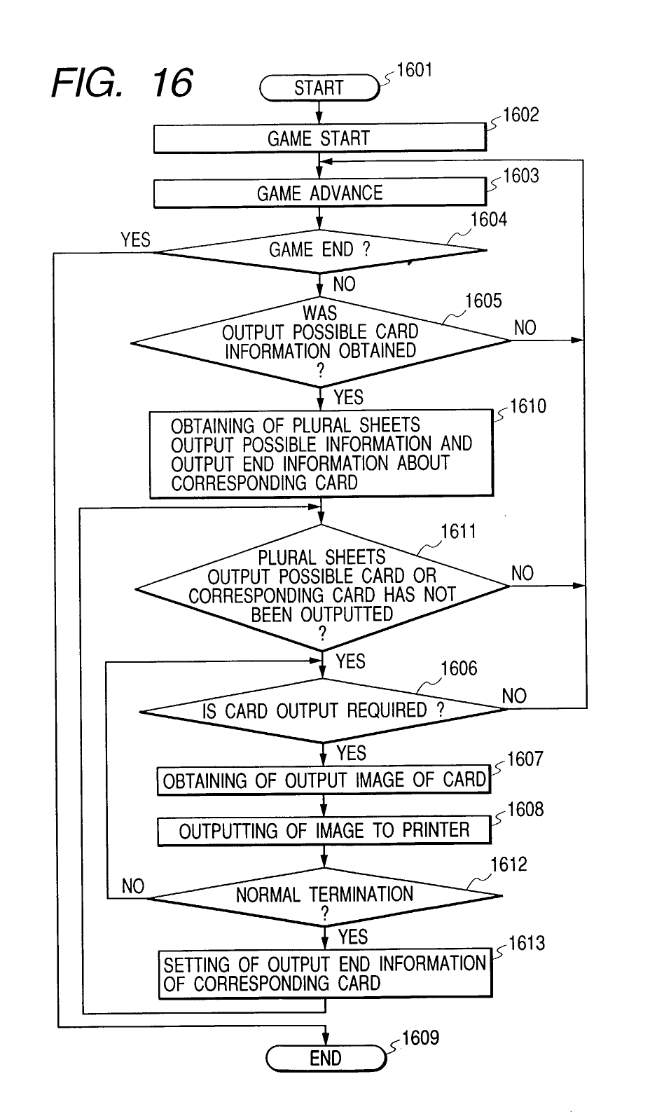

FIG. 16 is a flowchart showing a game program (which contains a normal game and involves card output) executed on the game machine 2 in the seventh embodiment. Steps 1601 through 1609 show the same operations as those conducted in steps 501 through 509 in FIG. 5. In step 1610, the already-outputted information is read from the non-volatile memory. Further, the possible-of-outputting-plural-sheets information is obtained from the ROM 22 or the game cartridge. In step 1611, it is judged whether the card concerned is categorized as a possible-of-outputting-plural-sheets card or a not-yet-outputted card. If a result of the judgment in step 1611 is “YES”, the processing proceeds to step 1606. If-the card concerned is judged to be the possible-of-outputting-plural-sheets card as well as being the already-outputted card, the processing returns to step 1603 without executing the output, wherein the progress of the normal game continues.

If the card output is implemented through steps 1606, 1607 and 1608, it is next confirmed in step 1612 whether the card output by the output device 1 is normally finished. If the card output can not come to the normal end for some reason (no storage of paper, no storage of paper, and an unexpected fault such as a power failure etc.), the processing loops back to step 1606, wherein it is again confirmed whether the card output is carried out or not.

If the card output comes to the normal end in step 1612, the processing proceeds to step 1613, wherein the already-outputted information of the card concerned is set. Normally, a value specifying (already-outputted) is set and saved in an already-outputted information area for this card in the nonvolatile memory. Then, the processing proceeds to step 1611. In step 1611, if the card concerned is categorized as the possible-of-outputting-plural-sheets card, the processing again loops back to 1606, in which it is confirmed whether the card output is continuously effected. If “YES” is selected in step 1606, the processing returns to step 1603, and it follows that the normal game continues.

As described above, it is feasible to control the scarcity value of the card by restricting the output sheet count of the card as in the sixth embodiment even by use of the plural-sheets-recordable flag.

(Eighth Embodiment)

A scheme in an eight embodiment is to change a card-output-count limitation count for every card and an output possibility flag on the game machine on which the game software is in the process of running.

Further, the inter-linkage between the game and the card can be strengthened by giving a card output permission and increasing the possible-of-output sheet count in a way that synchronizes with the progress of the game. With this scheme, the acquisition of the card organically interlinks with the progress of the game software, thereby making it possible to attract the user's interest in a way that gives, for instance, an output permission of the card corresponding to an opponent beaten in the game scenario.

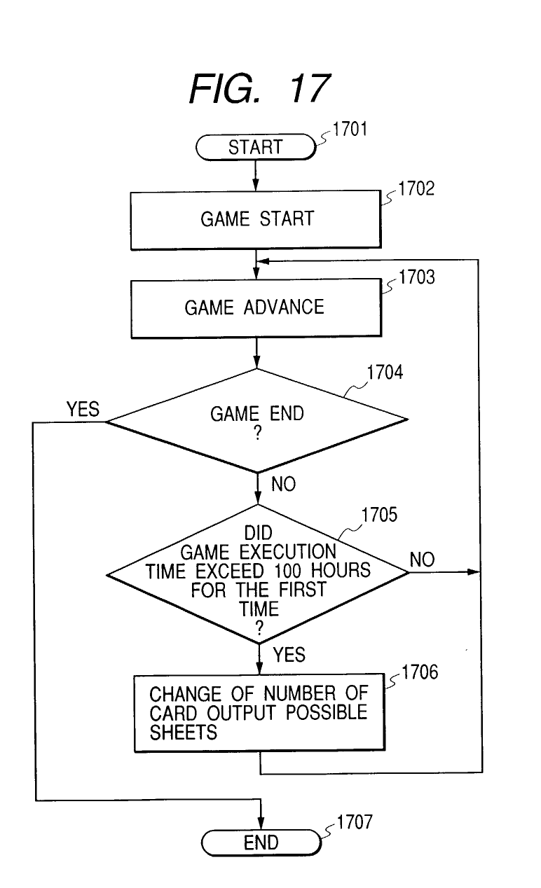

FIG. 17 is a flowchart showing a game program (which contains the normal game and involves the card output) executed on the game machine 2 in the eighth embodiment.

Steps 1701 through 1705 are executed in the same procedures as those in steps 501 through 504 in FIG. 5. In step 1705, it is judged whether a predetermined condition is met or not. The eighth embodiment takes a condition of whether a gaming time exceeds 100 hours for the first time. If not over 100 hours, or if the gaming time, though over 100 hours this time, has already exceeded 100 hours before, the processing proceeds to step 1703, wherein the progress of the normal game continues. If the gaming time is over 100 hours for the first time, the processing goes to step 1706, wherein the possible-of-output sheet count of the predetermined card is changed Generally, the possible-of-output sheet count is, after being incremented, stored on the nonvolatile memory. Thereafter, the processing loops back to step 1703, in which the progress of the normal game continues.

As described above, the scarcity value of the card can be varied by changing the restriction of the output sheet count of the card when meeting the predetermined condition during the game.

The eighth embodiment has exemplified, as the predetermined condition, the case in which the gaming time exceeds 100 hours for the first time. The present invention is not, however, limited to this condition, and the condition may take any form wherein the effects of the present invention can be actualized. For example, the possible-of-output sheet count may be changed interlinking with an event that a specified character appearing in the game performs behaviors such as (encounter), (parting), (joining companions), (fight), (victory), (defeat), (growth), (love), (marriage), (divorce), (get hearsay), (acquisition of predetermined item), (equipment), (birth), (hibernation), (ecdysis), (incubation), (death) etc. during the game, or that a specified item is (obtained), (purchased), (lost), (sold), (broken), (equipped), (used), (leased), (returned) etc. during the game. Moreover, other conditions may be (a game start-up count and a game final target are attained) or (an intermediate target in this process is attained) and so on.

These predetermined conditions have no necessity of being judged from the information on the single game machine, and may be judged from a part or the whole of the game information retained on a plurality of game machines under an environment in which the plurality of game machines are connected via a cable or wirelessly and can interchange the information with each other.

Further, the process executed when the predetermined condition is met is not limited to changing the possible-of-output sheet count of the card, and may take a form that can actualize the effects of the present invention. For instance, there may be effected the change of the possible-of-outputting-plural-sheets information and the already-outputted information described in the second embodiment.

(Ninth Embodiment)

In a ninth embodiment, the card output information is retained on the game machine in such a way that system save information contains the card output information.

If the game software sets the plural-outputs permission of the card and the output-count limitation count of the card in accordance with the progress of the game, and if the card output is actually effected once after the output-count limitation count of, e.g., the rare card has been set to 1, the output count is equalized to the limitation count, with the result that the card output over the number of sheets can not be executed.

If the card output can not be immediately executed for some reason in the state where the output-count limitation count is set to 1, this output-count limitation count needs retaining. In this case, it is desirable that the output-count limitation count be contained in the save information of the game. The save information contains what is generally called the system information.

As explained above, the output sheet count of the card can be restricted by saving the card output information on the nonvolatile memory. In the general game, the non-volatile memory is provided with a plurality of save areas in the case of saving stages of the progress of the game.

As an example of using the save areas, there is a method of providing a save area 1 and a save area 2, providing a setting for the user to select at first which save area is used when starting the game, and thereafter saving the stages of the progress of the game in the area selected at first. Then, in the case of resuming the game halfway, any one of the save area 1 and the save area 2 is selected for continuing the game.

The save method described above provides many cases in which there are generally prepared actions of copying the save information saved in the save area 1 is copied to the save area 2 and copying, by contrast, the save information saved in the save area 2 t the save area 1, thus enabling the user to take the copying action as the user desires.

In this case, if the card output information is stored in every save area, the card output information can be set back to the information before executing the card output by copying to the save area 2 a content in the save area 1 just before a card output event occurs (it is assumed that the accumulation output information of the concerned card in the save area indicates “0”), thereafter continuing the game from within the save area 1, effecting the card output (at this time, the accumulation output information of the concerned card in the save area 1 comes to “1”), and thereafter copying the content in the save area 2 to the save area 1 (the accumulation output information of the concerned card in the save area 1 returns to “0”). With this operation repeated, even when executing the output sheet count restricting process, substantially any number of sheets of the card can be outputted, resulting in a remarkable decline of the scarcity value of the card.

As can be understood from the discussion made so far, the card accumulation output count of the card is saved for every piece of save information, which means that the effect of the process of restricting the output count comes to substantially nothing, and hence there is a necessity of saving the card accumulation output count in a different form.

Such being the case, differently from each save area, the card accumulation output count is saved in a common system save area provided only by one in the single game cartridge, thereby making it possible to steer clear of this problem. Namely, the card accumulation output count is saved in the common save area, and hence the accumulation output count of the card that has been outputted once is saved in the common save area, whereby the limitless card output described above can be prevented.

(Tenth Embodiment)

A scheme in a tenth embodiment is to inhibit a copy of the game save information containing the card output information.

Normally, in the case of using the save information containing the card record information, an actual implementation of the card output involves recording a piece of information showing that the card output is implemented once. Alternatively, the recording is effected in a state where the output-count limitation count is set to “0”.

If the save information described above can be copied, a plurality of copies of the save information before implementing the card output, are prepared, and the card output can be effected a plurality of times by using each piece of save information. It is preferable for preventing this state that the game save information containing the card record information be inhibited from being copied.

In this case, the copy-inhibited save information may be saved in the plurality of save areas described in the fourth embodiment or in the common save area.

(Eleventh Embodiment)

A scheme in an eleventh embodiment is that the game save information containing the card output information is inhibited from being erased and initialized.

Even when inhibiting the copy, if the game information is erased and initialized, the same card output can be done by operating again from the beginning. Hence, the card output information is retained in the erasion/initialization inhibited area, whereby the rare card can be inhibited from being copied.

(Twelfth Embodiment)

In a twelfth embodiment, the card output information is retained outside the game machine (the information being retained on the installed-type card output device).

Supposing that the output of only one sheet of card is permitted during the game in the case of card output being effected by use of the save information within the game machine, the cards of which the number corresponds to the number of pieces of game software sold, come to appear on the market. Then, for providing a smaller number of rare cards appearing on the market than the number of cards sold, it is desirable that the output count be restricted by the output control unit. It is feasible to manage a total card output count of every card nationwide and worldwide as well by applying the output count restriction to each of the installed-type card output devices disposed nationwide and worldwide.

FIG. 7 is the explanatory system diagram showing an architecture of the card game system in the twelfth embodiment. The output device 1, the game machine 2, the display unit 3, the game cartridge insert port 4, the direction input button 5, the decision button 6A and the cancel button 6B are the same as those shown in FIG. 1 in the first embodiment. The output control device 9 is connected to the game machine 2 via the connection cable 7. The output control device 9, based on the information sent from the game machine 2, obtains and generates the card output information, and records a desired item of card information on the card 8 from the output device 1 via the connection cable 13.

Herein, the discussion will be focused on a system for outputting the card by using the output device 1 via the connection cable 7, the output control device 9 from the portable game machine 2 using the game cartridge. Unless specified otherwise, however, if premised that the functions of the present invention can be executed, the connection between the game machine 2 and the output control device 9 and the connection between the output control device 9 and the output device 1 may be attained not by the wired connection cables 7, 13 but by an infrared wireless network, and may also be attained not by the direction connections but via a plurality of devices. Further, the output control device 9 and the output device 1 may not be necessarily constructed separately and connected via the cable, and may also be constructed into one united body.

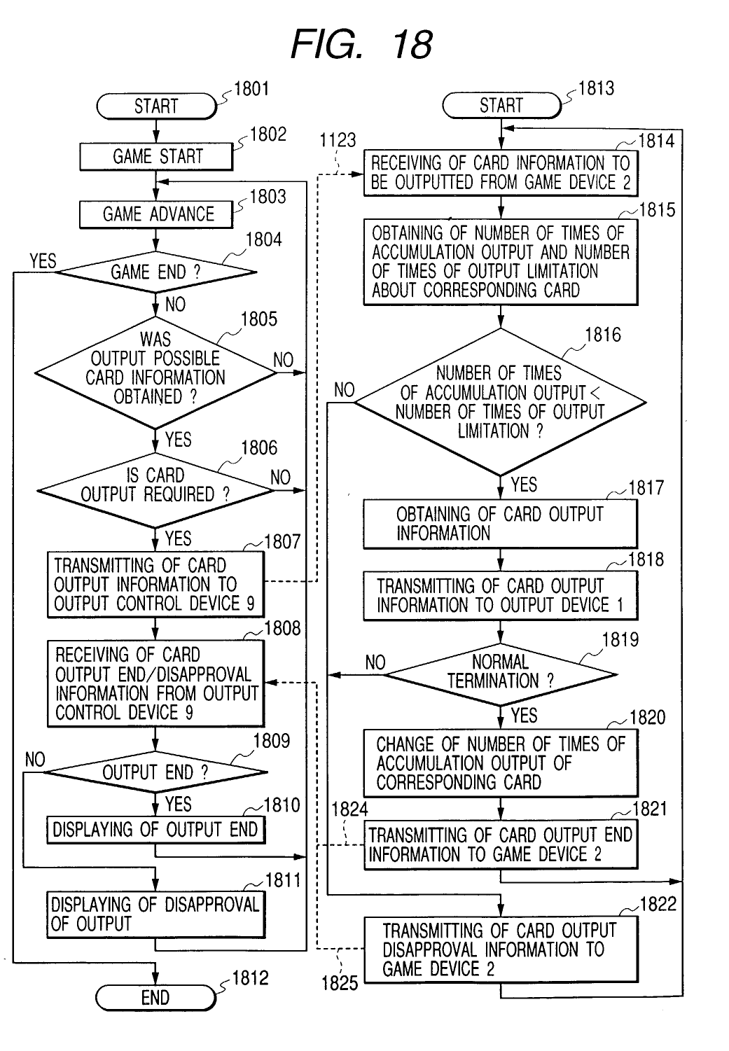

FIG. 8 is the block diagram showing the card game system in the twelfth embodiment. the CPU 21, the ROM 22, the RAM 23, the CTRG I/F24, the KB I/F25 and the LCD I/F26 in the game machine 2 are the same as those in FIG. 3 in the first embodiment. The PRT I/F27 is connected to the output control device 9 via the connection cable 7 and transfers the information such as the card information etc. outputted through the one-way or both-way communications. The CPU 91 controls the operations in the output control device 9 on the basis of programs (including a game program shown in a flowchart in FIG. 18, the card information, the card output images and so forth) stored on the ROM 92 or the HDD 95. Alternatively, the CPU 91 controls the operations of the output control device 9 on the basis of the programs stored on the storage medium such as a CD or a DVD etc. set in the CD/DVD DRIVE 96 in a way that reads these programs through the CD/DVD DRIVE 96. Further, the game program may be temporarily read into the internal RAM 93, and the program on the RAM 93 may also be executed. Moreover, the game program stored thereon and the card output information may be downloaded over the network via a NETWORK I/F97.

The GAME I/F94 is connected to the game machine 2 via the connection cable 7, and performs the one-way or both-way communications with the game machine, thus transferring the information such as the card information etc. to be outputted. The PRT I/F98 (printer interface) transfers the information between the output control device 9 and the output device 1 by use of a cable or wireless connection means (which is the connection cable 7 in FIG. 8). The one-way or both-way communications between the output control device 9 and the output device 1 are carried out. When performing the one-way communication, the information from the output control device 9 is transmitted to the output device 1. When performing the both-way communications, in addition to the transmission described above, the output control device 9 receives pieces of information (error processing information such as no storage of ink, no storage of paper, a paper jam etc.) from the output device 1. The output control device 9 transfers the information received from the output device 1 to the game machine 2 as the necessity arises. Alternatively, the game machine 2 may be connected directly to the output device 1.

FIG. 18 is a flowchart showing a game program (which contains the normal game and involves the card output) running on the game machine 2 and the output control device 9 in the twelfth embodiment. A program module consisting of steps 1801 through 1812 on the left side in FIG. 18 is executed inside the game machine 2. A program module consisting of steps 1813 through 1822 on the right side in FIG. 18 is executed inside the output control device 9. Dotted lines 1823 through 1825 in FIG. 18 indicate information transmitted and received between the game machine 2 and the output control device 9 via the connection cable 7.

To start with, the output control device 9 is kept in a standby status till it receives the output card information from the game machine 2 in step 1814 after the CPU 91 has started up an internal program of the HDD 95 simultaneously with power-ON of the power switch in step 1813.

In the game machine 2, in step 1801, simultaneously with power-ON of the power switch, the CPU 21 reads and starts up the program via the CTRG I/F24. In step 1802, the CPU 21 initializes the display unit 3 through the LCD I/F26 and also initializes the game itself, thereby starting the game. Next, the CPU 21 proceeds to step 1803 and progresses the game corresponding to the inputs from the direction button 5, the decision button 6A and the cancel button 6B through the KB I/F25. The CPU 21 proceeds to step 1804, wherein the CPU 21 checks whether the game is ended or not. If the end of the game is selected, the processing goes to step 1112, wherein the game ends. Alternatively, the game falls into a forced termination by turning OFF the unillustrated power switch.

If the game is not ended, the processing proceeds to step 1805. Herein, the CPU 21 judges whether there is obtained the card information that can be outputted during the game. If the possible-of-output card information is not obtained, the CPU 21 loops back to step 1803 and continues a progress of the normal game. If the possible-of-output card information is obtained, the CPU 21 proceeds to step 1806, wherein the CPU 21 displays on the display unit 3 a query about whether the card output is required, and prompts the player to select any one of “YES” and “NO” by use of the direction button 5. Then, a content of the selection is decided by pressing the decision button 6A. In this case, it may be considered the same as a meaning of selecting “NO” that the cancel button 6B is pressed. If “NO” is selected in step 1806, the CPU 21 diverts to step 1103 and continues the progress of the normal game. Whereas if “YES” is selected in step 1806, the CPU 21 proceeds to step 1807.

In step 1807, the game machine 2 transmits output card information 1823 to the output control device 9 via the connection cable 7. Then, the output control device 9 receiving the output card information 1123 goes to step 1815, wherein the CPU 91 obtains the accumulation output count and the output limitation count of the card corresponding to the possible-of-output card information that is stored on the HDD 95. Next, the CPU 91 judges in step 1816 whether the accumulation output count is less than the output limitation count. If judged to be “YES” in step 1816, this indicates that the accumulation output count has already been over the output restriction sheet count, and therefore the card output can not be executed. Then, the CPU 91 proceeds to step 1822. In step 1822, a piece of output disapproval information 1825 of the card is transmitted via the connection cable 7 to the game machine 2. Thereafter, the CPU 91 loops back to step 1814, and reverts to the standby status for waiting a next piece of output card information 1823.

If judged to be “YES” in step 1816, the card output can be executed, and the CPU 91 proceeds to step 1817. In step 1817, the CPU 91 obtains and generates an output image of the possible-of-output card concerned. In this case, the whole output image of the card may be stored on the HDD 95, or while retaining only the image information required at the minimum, the output control device 9 may synthesize and configure the output images based on the various categories of digital card information (consisting of the image 10, the name 11 and the comment field 12 containing the attribute, the stamina, the offensive power, the defensive power and the game scenario). After obtaining and generating the image information that should be outputted in step 1817, the processing proceeds to step 1818. In step 1818, the card 8 is outputted by transmitting the output image to the output device 1 through the connection cable 13 from the PRT I/F98. Then, upon finishing the card output, the processing goes to step 1819. In step 1819, it is judged based on the information transmitted from the output device 1 (errors such no storage of paper and no storage of ink, a paper jam etc.) whether the card output is normally ended or not. If judged not to be normally ended in step 1819, which means that the normal card output is not effected, the processing proceeds to step 1822. Thereafter, the CPU 91 loops back to step 1814 and reverts to the standby status for waiting a next piece of output card information 1823.

Whereas if judged to be normally ended in step 1819, the processing goes to step 1820, wherein the accumulation output count of the card concerned is modified, and a result thereof is saved on the HDD 95. Generally, on this occasion, the accumulation output count is incremented by 1. Next, the processing proceeds to step 1821, wherein card output end information 1824 is transmitted to the game machine 2. Upon finishing the transmission of the card output end information 1824, the CPU 91 loops back to step 1814, and reverts to the standby status for waiting a next piece of output card information 1823.

The game machine 2 receiving the card output end information 1824 or the card output disapproval information 1825 in step 1808, proceeds to step 1809 and judges a result of the card output. If the information received is categorized as the output end information 1824, the processing proceeds to step 1810, wherein it is displayed on the display unit 3 that the card output is normally ended. Thereafter, processing goes to step 1803, wherein the progress of the normal game continues. The progress of the normal game and the card output are thereafter repeated corresponding to a state of obtaining the possible-of-output card information till the end of the game is selected in step 1804.

If the information received in step 1809 is categorized as the card output disapproval information, the processing diverts to step 1811, wherein a reason for the disapproval of the card output is that the card accumulation output count is equal to or larger than the output limitation count or that the card output is not normally ended, is displayed on the display unit 3. Thereafter, the processing loops back to step 1803, wherein the normal game continues. The progress of the normal game and the card output are thereafter repeated corresponding to the state of obtaining the possible-of-output card information till the end of the game is selected in step 1804.

As described above, the scarcity value of the card can be strongly controlled by restricting the output sheet count in the output control device 9 and by setting the restriction sheet count smaller than the quantity of the games (the number of game programs) appearing on the market.

The discussion on the twelfth embodiment has been dealt with the system in which the output control device 9 outputs the card each time the card acquisition event occurs. In this case, however, when the portable game machine actually acquires the possible-of-output card, the cards must be outputted sheet by sheet in a way that establishes the connection to the output control device 9 each time. Further, if the output control device 9 does not exist nearby, the user is forced to select “YES” in response to a query about the card output in order to progress the game or to select a stop of the progress of the game till the connection to the output control device 9 is established.

Such being the case, a scheme capable of improving the problem described above is that the card output approval information is retained within the game machine, and the output device 9 is so structured to output the approved card anytime. With this scheme, a much smoother progress of the game can be actualized.

Any of the embodiments discussed above does not need adopting exclusively, and the smooth progress of the game can be attained by using the two methods in combination.

Further, it is also possible to provide new cars with new designs by periodically updating the contents in the HDD 95 in the output control device 9. Normally, pieces of CD-ROM formatted and ROM cassette formatted game software are, if once sold, very hard to add functions and cards thereafter. If using the output control device 9 according to the present invention, however, the ever-updated cards can be outputted by use of the HDD 95 or CD/DVD DRVE 96 and further by downloading via the NETWORK I/F97.

(Thirteenth Embodiment)

According to a thirteenth embodiment, the card output information is retained outside the game machine (the information being retained on a server).

Similarly, the installed-type card output control units 9 described above are connected via the NETWORK I/F97, and the output counts are restricted on the nationwide/worldwide basis, thereby making it possible to manage the total card output count for every card nationwide and worldwide as well

(Fourteenth, Embodiment)

None of the sixth through thirteenth embodiments discussed above needs adopting exclusively, and the card output sheet count can be controlled more surely by using the respective embodiments in combination. Unless used in combination, (example: if a predetermined condition is met during the game, 100 cards at the maximum can be outputted nationwide) it follows that the user who meets the predetermined condition for the first time during the game, is able to output 100 cards alone. For avoiding this state, it is effective to utilize the output count restriction on the nationwide basis and the output count restriction on the game machine in combination, or utilize the output count restriction on the nationwide basis and the output count restriction on the installed-type card output device in combination, or utilize all the above-mentioned three types of card output count restrictions in combination.

As many apparently widely different embodiments of the present invention can be made without departing from the spirit and scope thereof, it is to be understood that the invention is not limited to the specific embodiments thereof except as defined in the claims.

What is claimed is:

1. A program for making a computer device execute a game, comprising:
making said computer device progress the game; and
making said computer device control a print of an mage corresponding to a progress of the game.

2. A program according to claim 1, further comprising causing an occurrence of an event for enabling the image to be printed when the progress of the game reaches a predetermined condition.

3. A program according to claim 2, wherein the image contains pieces information related to characters and items appearing in the event.

4. A program according to claim 1, wherein said program is stored on a cartridge and thus supplied to said computer device.

5. A program according to claim 1, further comprising controlling so that the image corresponding to the progress of the game is printed after an end of the game.

6. A program according to claim 1, further comprising changing, based on a predetermined condition, the image printed corresponding to the progress of the game.

7. A program according to claim 6, wherein the predetermined condition is an output time.

8. A program according to claim 1, wherein the image is printed on a card of which a content is readable by a predetermined reader.

9. A program according to claim 1, wherein the image contains information of which a content is readable by a predetermined reader.

10. A program according to claim 1, further comprising making said computer device restrict the number of prints of the image when printing the image wherein the image is printed on a card of which a content is readable by a predetermined reader.

11. A program according to claim 10, further comprising making the number of the restricted prints different corresponding to the image.

12. A program according to claim 10, further comprising changing the number of the restricted prints of the image corresponding to a stage of progress of the game.

13. A program according to claim 10, further comprising storing predetermined non-volatile storage means with information on the print restriction of the image together with save information of the game.

14. A program according to claim 10, further comprising storing predetermined non-volatile storage means with information on the print restriction of the image together and save information of the game separately and independently.

15. A program according to claim 10, further comprising inhibiting a copy or erasion of the information on the print restriction of the image.

16. A program according to claim 10, further comprising retaining the information on the print restriction of the image on a device other than said computer device.

17. A computer device capable of executing a game on the basis of a given program, comprising:
control means for controlling a progress of the game on the basis of said program; and
print control means for controlling a print of the image in accordance with the progress of the game.

18. A control method of controlling a computer device capable of executing a game on the basis of a given program, comprising:
controlling a progress of the game on the basis of said program; and
controlling a print of the image in accordance with the progress of the game.

19. A storage medium stored with a program for making a computer device execute a game, said program comprising:
making said computer device progress the game; and
making said computer device control a print of the image in accordance with the progress of the game.

20. A program for making a computer device execute a game and transmitting a signal for making an image forming apparatus print an image, said program comprising:
making said computer device progress the game; and
transmitting a signal for making said computer device control the print of the image in accordance with the progress of the game.
